(19) United States
(12) Patent Application Publication
(10) Pub. No.: US 2025/0069177 A1
(43) Pub. Date: Feb. 27, 2025

(54) TRANSPORTATION PLAN CREATION SUPPORT APPARATUS, TRANSPORTATION PLAN CREATION SUPPORT METHOD, AND NON-TRANSITORY STORAGE MEDIUM

(71) Applicant: NEC Corporation, Minato-ku, Tokyo (JP)

(72) Inventors: Norihito OI, Tokyo (JP); Tooru IWAMOTO, Tokyo (JP); Takuroh KASHIMA, Tokyo (JP); Tomoaki MAKINO, Tokyo (JP)

(73) Assignee: NEC Corporation, Minato-ku, Tokyo (JP)

(21) Appl. No.: 18/722,767

(22) PCT Filed: Dec. 28, 2021
(86) PCT No.: PCT/JP2021/048797

§ 371 Date: Jun. 21, 2024

(51) Int. Cl. G06Q 50/40; B60L 58/12

(52) U.S. Cl. CPC G06Q 50/40; B60L 58/12; B60L 2200/36

(57) ABSTRACT

A transportation plan acquisition unit (11) acquires a transportation plan including a transportation destination, an order of transportation, and a weight of a cargo. A terminal departure time state of charge (SOC) acquisition unit (12) acquires an SOC of a vehicle at a time of departure from a terminal. An SOC change prediction unit (13) determines, based on the transportation plan, a load during transportation changing in response to loading and unloading of the cargo during transportation, and predicts, based on the determined load, a change of an SOC of the vehicle during transportation when transportation following the transportation plan is performed. A determination unit (14) determines whether a point where an SOC drops below a reference value exists in a change of an SOC of the vehicle during transportation. A determination result output unit (15) outputs a result of the determination.

### TECHNICAL FIELD

The present invention relates to a transportation plan creation support apparatus, a transportation plan creation support method, and a program.

### BACKGROUND ART

A technique related to an electric vehicle is disclosed in each of Patent Documents 1 and 2.

Patent Document 1 discloses a technique for determining whether an electricity failure occurs when delivery is performed based on a delivery plan, and lowering an upper limit of a total travel distance and recreating a delivery plan when it is determined that an electricity failure occurs.

Patent Document 2 discloses a technique for estimating electricity consumption of an electric vehicle in consideration of a load of the electric vehicle, an operation state of an air conditioner, a driving tendency of a driver, a weather condition, congestion status of a travel route, and the like.

### RELATED DOCUMENT

### Patent Document

Patent Document 1: International Patent Publication No. WO2020/158073

Patent Document 2: Japanese Patent Application Publication No. 2019-86430

### DISCLOSURE OF THE INVENTION

### Technical Problem

However, when transportation is performed by use of an electric vehicle, a load of the electric vehicle changes in response to loading and unloading of a cargo during transportation, and electricity consumption also changes accordingly. Neither of the techniques disclosed in Patent Documents 1 and 2 takes this point into consideration.

An object of the present invention is to accurately create a transportation plan in such a way that an electricity failure does not occur along a way.

### Solution to Problem

The present invention provides a transportation plan creation support apparatus including:
a transportation plan acquisition unit that acquires a transportation plan including a transportation destination, an order of transportation, and a weight of a cargo;
a terminal departure time state of charge (SOC) acquisition unit that acquires an SOC of a vehicle at a time of departure from a terminal;
an SOC change prediction unit that determines, based on the transportation plan, a load during transportation changing in response to loading and unloading of the cargo during transportation, and predicts, based on the determined load, a change of an SOC of the vehicle during transportation when transportation following the transportation plan is performed;
a determination unit that determines whether a point where an SOC drops below a reference value exists in a change of an SOC of the vehicle during transportation; and
a determination result output unit that outputs a result of the determination.

Moreover, the present invention provides a transportation plan creation support method including,
by a computer executing:
   a transportation plan acquisition step of acquiring a transportation plan including a transportation destination, an order of transportation, and a weight of a cargo:
   a terminal departure time SOC acquisition step of acquiring an SOC of a vehicle at a time of departure from a terminal;
   an SOC change prediction step of determining, based on the transportation plan, a load during transportation changing in response to loading and unloading of the cargo during transportation, and predicting, based on the determined load, a change of an SOC of the vehicle during transportation when transportation following the transportation plan is performed;
   a determination step of determining whether a point where an SOC drops below a reference value exists in a change of an SOC of the vehicle during transportation; and
   a determination result output step of outputting a result of the determination.

Moreover, the present invention provides a program causing a computer to function as:

a transportation plan acquisition unit that acquires a transportation plan including a transportation destination, an order of transportation, and a weight of a cargo;
a terminal departure time SOC acquisition unit that acquires an SOC of a vehicle at a time of departure from a terminal;
an SOC change prediction unit that determines, based on the transportation plan, a load during transportation changing in response to loading and unloading of the cargo during transportation, and predicts, based on the determined load, a change of an SOC of the vehicle during transportation when transportation following the transportation plan is performed;
a determination unit that determines whether a point where an SOC drops below a reference value exists in a change of an SOC of the vehicle during transportation; and
a determination result output unit that outputs a result of the determination.

### Advantageous Effects of Invention

The present invention can accurately create a transportation plan in such a way that an electricity failure does not occur along a way.

### BRIEF DESCRIPTION OF THE DRAWINGS

FIG. 1 It is a diagram illustrating one example of a hardware configuration of a transportation plan creation support apparatus.

FIG. 2 It is one example of a functional block diagram of a transportation plan creation support apparatus.

FIG. 3 It is a diagram schematically illustrating one example of information that the transportation plan creation support apparatus processes.

FIG. 4 It is a diagram schematically illustrating one example of information that the transportation plan creation support apparatus outputs.

FIG. 5 It is a flowchart illustrating one example of a flow of processing of the transportation plan creation support apparatus.

FIG. 6 It is a flowchart illustrating one example of a flow of processing of the transportation plan creation support apparatus.

FIG. 7 It is a diagram schematically illustrating one example of information that the transportation plan creation support apparatus outputs.

FIG. 8 It is a diagram schematically illustrating one example of information that the transportation plan creation support apparatus outputs.

FIG. 9 It is a flowchart illustrating one example of a flow of processing of the transportation plan creation support apparatus.

FIG. 10 It is a diagram schematically illustrating one example of information that the transportation plan creation support apparatus outputs.

FIG. 11 It is a diagram schematically illustrating one example of information that the transportation plan creation support apparatus outputs.

### DESCRIPTION OF EMBODIMENTS

Hereinafter, example embodiments of the present invention are described by use of the drawings. Note that, in all of the drawings, a similar component is assigned with a similar reference sign, and description thereof is omitted as appropriate. Note that, an “electric vehicle” powered by electricity is hereinafter simply referred to as a “vehicle”. In other words, the “vehicle” referred to below is an “electric vehicle”. Moreover, “transportation” in the present specification is a concept including both delivering a cargo to a transportation destination and collecting the cargo at the transportation destination.

### FIRST EXAMPLE EMBODIMENT

### “Outline”

A transportation plan creation support apparatus according to the present example embodiment has a function of determining, when a transportation plan is acquired, whether an electricity failure of a vehicle occurs when transportation following the acquired transportation plan is performed.

More specifically, the transportation plan creation support apparatus acquires “a transportation plan including a transportation destination, an order of transportation, and a weight of a cargo” and “an SOC of a vehicle at a time of departure from a terminal”.

Subsequently, the transportation plan creation support apparatus determines, based on a transportation plan, a load during transportation changing in response to loading and unloading of the cargo during transportation.

Subsequently, the transportation plan creation support apparatus predicts, based on the determined load, a change of an SOC of the vehicle during transportation when transportation following the transportation plan is performed.

Then, the transportation plan creation support apparatus determines whether a point where an SOC drops below a reference value exists in a change of an SOC of the vehicle during transportation, and outputs a result of the determination.

### Hardware Configuration

Next, one example of a hardware configuration of the transportation plan creation support apparatus is described. Each functional unit of the transportation plan creation support apparatus is achieved by any combination of hardware and software mainly including a central processing unit (CPU) of any computer, a memory, a program loaded onto the memory, a storage unit such as a hard disk that stores the program (that can store not only a program previously stored from a phase of shipping an apparatus but also a program downloaded from a storage medium such as a (compact disc) CD or a server or the like on the Internet), and an interface for network connection. Then, it is appreciated by a person skilled in the art that there are a variety of modified examples of a method and an apparatus for the achievement.

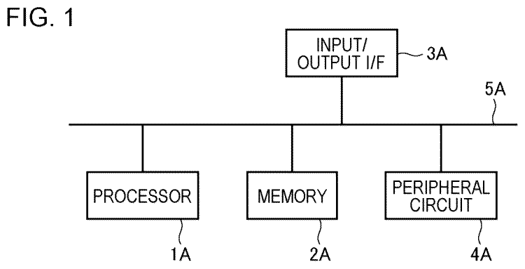

FIG. 1 is a block diagram illustrating a hardware configuration of the transportation plan creation support apparatus. As illustrated in FIG. 1, the transportation plan creation support apparatus includes a processor 1A, a memory 2A, an input/output interface 3A, a peripheral circuit 4A, and a bus 5A. The peripheral circuit 4A includes various modules. The transportation plan creation support apparatus may not include the peripheral circuit 4A. Note that, the transportation plan creation support apparatus may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic result of each of the modules.

### Functional Configuration

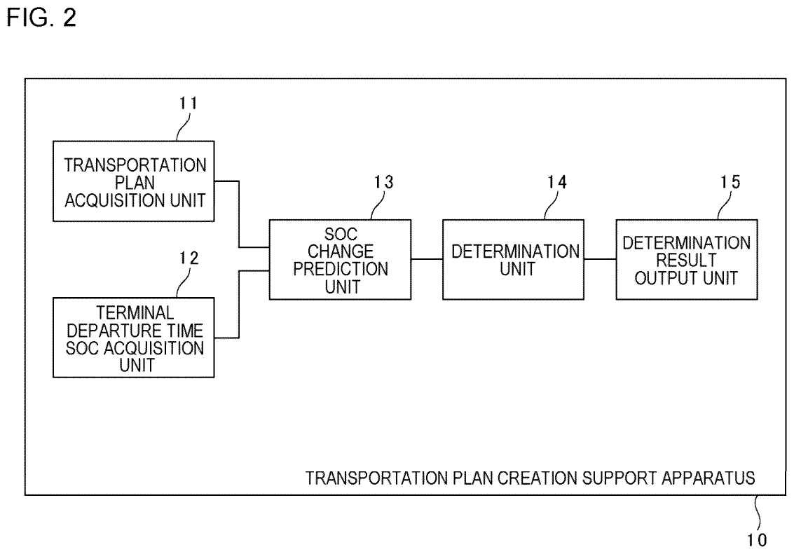

Next, a functional configuration of the transportation plan creation support apparatus is described. FIG. 2 illustrates one example of a functional block diagram of a transportation plan creation support apparatus 10. As illustrated, the transportation plan creation support apparatus 10 includes a transportation plan acquisition unit 11, a terminal departure time SOC acquisition unit 12, an SOC change prediction unit 13, a determination unit 14, and a determination result output unit 15.

The transportation plan acquisition unit 11 acquires a transportation plan including a transportation destination, an order of transportation, and a weight of a cargo (a cargo to be delivered or a cargo to be collected).

The transportation plan acquisition unit 11 may acquire a transportation plan by accepting an input of the transportation plan. Alternatively, the transportation plan acquisition unit 11 may create a transportation plan. Creation of a transportation plan is achieved by utilizing any technique. For example, the transportation plan acquisition unit 11 may create a transportation plan by use of a technique described in Non-Patent Document 1.

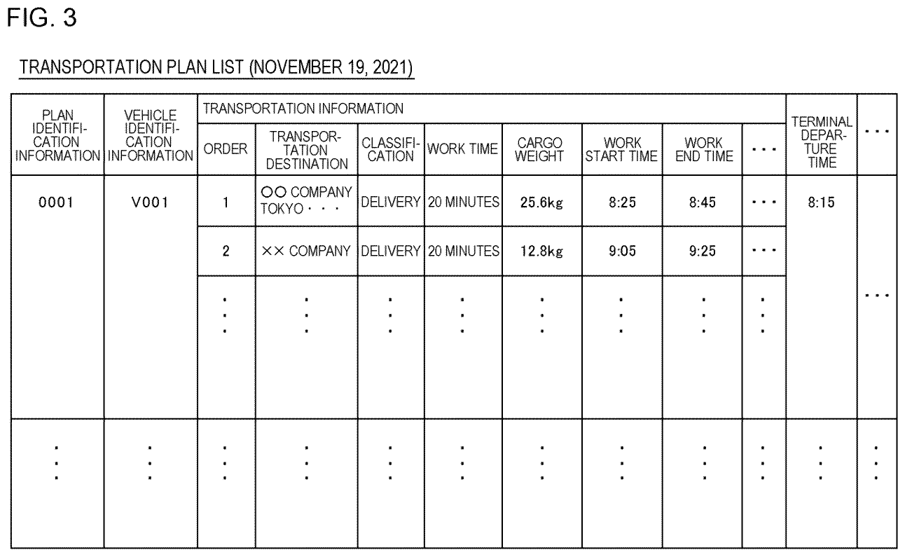

FIG. 3 schematically illustrates one example of a transportation plan acquired by the transportation plan acquisition unit 11. In FIG. 3, a plurality of delivery plans for Nov. 19, 2021 are displayed by a list. In FIG. 3, plan identification information, vehicle identification information, transportation information, and a terminal departure time are associated with each other. Note that, a transportation plan may include other pieces of information.

“Plan identification information” is information for mutually identifying a plurality of transportation plans.

“Vehicle identification information” is information for mutually identifying a plurality of vehicles utilized for transportation. Each piece of plan identification information is associated with vehicle identification information of a vehicle allocated to each transportation plan. “Transportation information” includes an order, a transportation destination, classification, a work time, a cargo weight, a work start time, and a work end time.

“Order” indicates an order of transportation.

“Transportation destination” indicates a name and an address of a party to whom a cargo is to be delivered, or a party from whom a cargo is to be collected.

“Classification” indicates a type of work, i.e. delivery or collection.

“Work time” indicates a time required for work (delivery or collection) to be performed at a transportation destination.

“Cargo weight” indicates a weight of a cargo to be delivered to a delivery destination, or a cargo to be collected at a collection destination.

“Work start time” indicates a time when work (delivery or collection) is started at a transportation destination.

“Work end time” indicates a time when work (delivery or collection) ends at a transportation destination.

“Terminal departure time” indicates a time when a vehicle departs from a terminal such as an office. After departing from the terminal, the vehicle goes around a plurality of transportation destinations, and thereafter returns to the terminal again. A terminal of departing and a terminal of returning may be the same, or may be different.

Returning to FIG. 2, the terminal departure time SOC acquisition unit 12 acquires an SOC of a vehicle at a time of departure from a terminal. The terminal departure time SOC acquisition unit 12 acquires an SOC of a vehicle at a time of departure from a terminal at any timing before the vehicle departs from the terminal.

For example, a user may input an SOC of a vehicle at a time of departure from a terminal to the transportation plan creation support apparatus 10. Then, the terminal departure time SOC acquisition unit 12 may acquire the SOC of the vehicle at the time of departure from the terminal input by the user. For example, the user views information displayed by an in-vehicle apparatus or the like mounted in the vehicle, at any timing between end of business on a previous day and a time of departure from a terminal on a current day, and thereby confirms an SOC of the vehicle at the time point. Then, the user inputs the confirmed SOC of the vehicle to the transportation plan creation support apparatus 10 as an SOC of the vehicle at the time of departure from the terminal.

Alternatively, the terminal departure time SOC acquisition unit 12 may communicate with an in-vehicle apparatus mounted in each of a plurality of vehicles utilized for transportation, and acquire an SOC of each of the vehicles from each of the in-vehicle apparatuses. For example, the terminal departure time SOC acquisition unit 12 acquires, at any timing between end of business on a previous day and a time of departure from a terminal on a current day, an SOC of each of the vehicles at the time point from each of the in-vehicle apparatuses, as an SOC of the vehicle at a time of departure from a terminal.

Alternatively, the terminal departure time SOC acquisition unit 12 may acquire, from a management apparatus that manages an SOC of each of a plurality of vehicles utilized for transportation, an SOC of each of the vehicles. The management apparatus acquires, at any timing between end of business on a previous day and a time of departure from a terminal on a current day, an SOC of each of the vehicles at the time point from each of the in-vehicle apparatuses. Then, the departure an SOC acquisition unit 12 acquires the SOC from the management apparatus as an SOC of the vehicle at the time of departure from the terminal.

The SOC change prediction unit 13 determines, based on a transportation plan, a load during transportation changing in response to loading and unloading of a cargo during transportation. Then, the SOC change prediction unit 13 predicts, based on the determined load, a change (change over time) of an SOC of the vehicle during transportation when transportation following the transportation plan is performed.

### Method of Determining a Load During Transportation

As illustrated in FIG. 3, a transportation plan indicates an order of transportation and a weight of a cargo to be transported at each transportation destination. By use of the information, a load during transportation can be determined.

First, by adding up cargo weights relevant to classification “delivery” in FIG. 3, a load from a terminal of departing to a first transportation destination (hereinafter, “load at departure”) can be computed.

Then, when classification of the first transportation destination is “delivery”, a load from the first transportation destination to a second transportation can be computed by subtracting a weight of a cargo to be delivered at the first transportation destination from a load at departure.

On the other hand, when classification of the first transportation destination is “collection”, a load from the first transportation destination to the second transportation destination can be computed by adding, to a load at departure, a weight of a cargo to be collected at the first transportation destination.

In the following, a load from a certain transportation destination to a next transportation destination, and a load to a terminal to return from a final transportation destination can be similarly computed.

### Method of Predicting a Change (Change Over Time) of an SOC of a Vehicle During Transportation

The SOC change prediction unit 13 divides a section from a terminal of departing to a terminal of returning into a plurality of sections. Specifically, the SOC change prediction unit 13 defines, as one section, each of sections “from a terminal of departing to a first transportation destination”, “from the first transportation destination to a second transportation destination”, “from the second transportation destination to a third transportation destination”, . . . , “from a final transportation destination to a terminal of returning”.

Then, for each section, the SOC change prediction unit 13 computes a change of an SOC in consideration of a load of each section and an SOC at start of each section (synonymous with an SOC at end of an immediately preceding section), connecting the changes in chronological order, and thereby predicts a change of an SOC of the vehicle from the terminal of departing to the terminal of returning. A method of predicting a change of an SOC in consideration of a load is not particularly limited, and any technique can be adopted. For example, machine learning or another existing technique may be utilized. One example is described below, but the present invention is not limited thereto.

For example, the SOC change prediction unit 13 determines electricity consumption (km/kWh) of a vehicle for each section. Electricity consumption is determined in consideration of a load of each section, information relating to a path passed in each section (pavement status of a road, expected congestion status of a road, inclination status of a road, a curvature radius of a curve existing in a path, the number of right and left turns existing in a path, and the like), a weather condition of a current day (weather, temperature, humidity, a wind speed, and the like), a vehicle type, air resistance depending on a vehicle type, power consumption due to mounting, and the like. Information relating to a path passed in each section is determined based on previously prepared map data. The map data indicate pavement status at each position, general congestion status, inclination status, a curvature radius of a curve, and the like.

For each condition generated by connecting these items with a logical operator, a reference table that registers electricity consumption when the condition is satisfied may be previously registered in a storage unit of the transportation plan creation support apparatus 10. Then, the SOC change prediction unit 13 may search for a condition that each section satisfies, and determine electricity consumption for each section. The condition is, for example, “load: equal to or more than X1 [kg], weather: sunny, temperature: equal to or more than 15°° C. and equal to or less than 25° C., . . . ” or the like. Alternatively, an arithmetic expression for computing electricity consumption by inputting a value of the above item may be previously generated, and registered in the storage unit of the transportation plan creation support apparatus 10. Then, the SOC change prediction unit 13 may input the value of the above item to the arithmetic expression for each section, and determine electricity consumption for each section.

Alternatively, a learning model may be generated that estimates electricity consumption from a combination of values of a plurality of types of the above items by machine learning based on training data associating a combination of values of a plurality of types of the above items with electricity consumption when a plurality of types of the above items take the values. Then, the SOC change prediction unit 13 may input the value of the above item to the learning model for each section, and determine electricity consumption for each section.

Then, the SOC change prediction unit 13 assumes that electric power is consumed in each section with electricity consumption for each section, and computes a change of an SOC of the vehicle during transportation, i.e., a change of an SOC of the vehicle from a terminal of departing to a terminal of returning.

The determination unit 14 determines whether a point where an SOC drops below a reference value exists in a change of an SOC of the vehicle during transportation. A reference value is previously set. For example, any value such as “5%”, “15%”, “30%” can be set as a reference value. A reference value may be set by the user.

The determination result output unit 15 outputs a result of determination by the determination unit 14. The determination result output unit 15 can output the result of determination via any output apparatus such as a display, a projection apparatus, a speaker, or a printer.

The result of determination indicates whether a point where an SOC drops below the reference value exists in a change of an SOC of the vehicle during transportation.

Moreover, when a point where an SOC drops below the reference value exists in a change of an SOC of a vehicle during transportation, the point of dropping may be indicated. The “point” may be indicated by a time such as “2:50 p.m. or later”, or may be indicated by use of information of a transportation destination such as “in or after a section between a sixth transportation destination and a seventh transportation destination”. The information indicates how far one can go in a state where an SOC does not drop below a reference value.

Moreover, when a point where an SOC drops below the reference value exists in a change of an SOC of a vehicle during transportation, an electric power amount that is insufficient in order to perform the transportation plan in such a way that an SOC does not drop below the reference value may be indicated. By utilizing electricity consumption determined for each section as described above, an electric power amount required after an SOC drops below the reference value may be computed.

When a point where an SOC drops below the reference value does not exist, it can be understood that there is no problem with the transportation plan (theoretically, there is no possibility that an electricity failure occurs during transportation). On the other hand, when a point where an SOC drops below the reference value exists, it can be understood that there is a problem with the transportation plan (theoretically, there is a possibility that an electricity failure occurs during transportation). Thus, it can be understood that review of the transportation plan, recreation of a transportation plan, and a feedback to a system that creates a transportation plan, and the like are necessary.

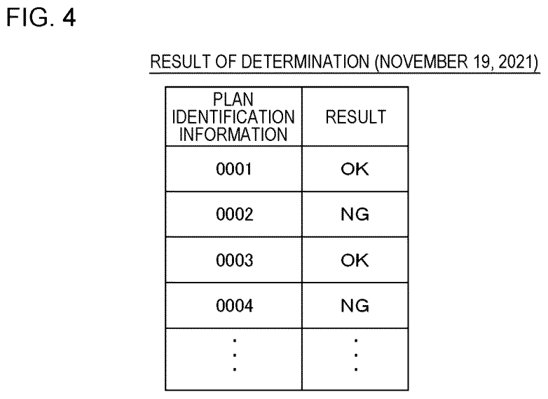

Note that, when the transportation plan acquisition unit 11 acquires a plurality of transportation plans, the determination result output unit 15 may display, by a list, a result of determination of each of the plurality of transportation plans, as illustrated in FIG. 4. In a case of an illustrated example, a result of a transportation plan in which a point where an SOC drops below the reference value in a change of an SOC of a vehicle during transportation does not exist is “OK”, and a result of a transportation plan in which a point where an SOC drops below the reference value exists is “NG”. Moreover, an SOC of a point where an SOC becomes lowest in a change of an SOC of a vehicle during transportation may be displayed as a result.

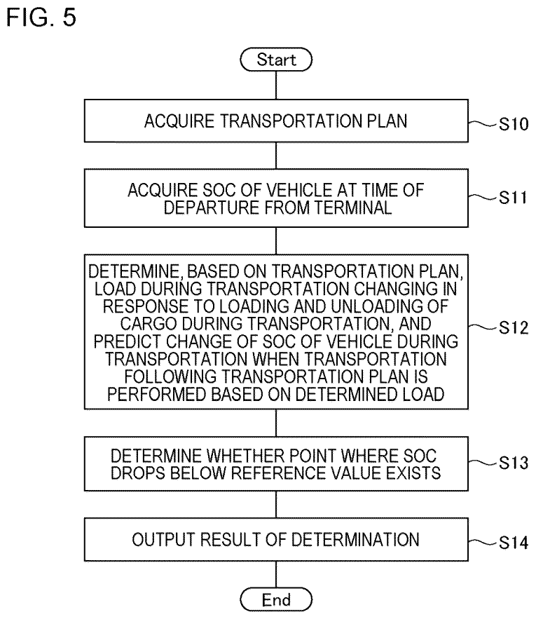

Next, one example of a flow of processing of the transportation plan creation support apparatus 10 is described by use of a flowchart in FIG. 5.

In S10, the transportation plan creation support apparatus 10 acquires a transportation plan including a transportation destination, an order of transportation, and a weight of a cargo. The transportation plan creation support apparatus 10 acquires a transportation plan before executed. For example, the transportation plan creation support apparatus 10 may acquire a transportation plan a day before an execution date. The transportation plan creation support apparatus 10 may acquire one transportation plan, or may acquire a plurality of transportation plans. Moreover, the transportation plan creation support apparatus 10 may create a transportation plan, or may receive an input of an already created transportation plan.

At S11, the transportation plan creation support apparatus 10 acquires an SOC of a vehicle at a time of departure from a terminal. The transportation plan creation support apparatus 10 acquires an SOC, at a time of departure from a terminal, of a vehicle allocated to the transportation plan acquired in S10. A method of acquiring an SOC of a vehicle at a time of departure from a terminal is as described above.

In S12, the transportation plan creation support apparatus 10 determines, based on the transportation plan, a load during transportation changing in response to loading and unloading of the cargo during transportation, and predicts a change of an SOC of the vehicle during transportation when transportation following the transportation plan is performed based on the determined load. Details of the processing are as described above.

In S13, the transportation plan creation support apparatus 10 determines whether a point where an SOC drops below the reference value exists in a change of an SOC of the vehicle during transportation predicted in S12.

In S14, the transportation plan creation support apparatus 10 outputs a result of determination at S13.

### Advantageous Effect

The transportation plan creation support apparatus 10 according to the present example embodiment determines, based on a transportation plan including a transportation destination, an order of transportation, and a weight of a cargo, a load during transportation changing in response to loading and unloading of the cargo during transportation, and predicts, based on the determined load, a change of an SOC of the vehicle during transportation when transportation following the transportation plan is performed. Then, the transportation plan creation support apparatus 10 determines, based on the predicted change of an SOC, whether an electricity failure of a vehicle occurs when transportation following the transportation plan is performed.

Thus, a change of an SOC of a vehicle can be accurately predicted by predicting a change of an SOC of the vehicle during transportation in consideration of a load during transportation changing in response to loading and unloading of a cargo during transportation. As a result, whether an electricity failure of a vehicle occurs during transportation can be accurately determined.

Moreover, a load during transportation can be determined with high accuracy by determining, based on a transportation plan including a transportation destination, an order of transportation, and a weight of a cargo, a load during transportation changing in response to loading and unloading of a cargo during transportation. As a result, a change of an SOC can be predicted with high accuracy, and whether an electricity failure of a vehicle occurs during transportation can be accurately determined.

### SECOND EXAMPLE EMBODIMENT

A transportation plan creation support apparatus 10 according to the present example embodiment is different from that according to the first example embodiment in having a function of reviewing (a function of correcting) a transportation plan in which a point where an SOC drops below the reference value exists in a change of an SOC of a vehicle during transportation. A detailed description is given below.

A determination unit 14 determines whether charging of a vehicle is possible before departure from a terminal, in a transportation plan in which an SOC drops below a reference value in a change of an SOC of the vehicle during transportation. Then, when charging of the vehicle is possible before departure from the terminal, the determination unit 14 computes a charge amount (hereinafter, “first charge amount”) of charging performed before departure from the terminal. Then, the determination unit 14 determines whether a point where an SOC drops below a reference value exists in a change of an SOC of the vehicle during transportation when charging is performed by the first charge amount before departure from the terminal. Each piece of processing is described in detail below.

Processing of Determining Whether Charging of a Vehicle is Possible Before Departure from a Terminal

The determination unit 14 determines whether charging of a vehicle is possible before departure from a terminal, in a transportation plan in which an

SOC drops below a reference value in a change of an SOC of the vehicle during transportation. The determination unit 14 determines whether charging of a vehicle is possible before departure from a terminal, based on at least one of an SOC of the vehicle at a time of departure from the terminal, a time between an arrival time of a worker and a terminal departure time, and reservation status of a charging facility.

For example, the determination unit 14 may determine “Condition 1: an SOC of a vehicle at a time of departure from a terminal acquired by a terminal departure time SOC acquisition unit 12 is not 100%”. When the condition 1 is not satisfied, i.e. when an SOC of the vehicle at the time of departure from the terminal is 100%, the determination unit 14 determines that charging of the vehicle is impossible before departure from the terminal. Then, when the condition 1 is satisfied, i.e. when an SOC of the vehicle at the time of departure from the terminal is not 100%, the determination unit 14 determines that charging of the vehicle is possible before departure from the terminal.

Alternatively, the determination unit 14 may determine “Condition 2: A time between a terminal departure time indicated in the transportation plan (see FIG. 3) and an arrival time of a worker is equal to or more than a reference time”.

When the condition 2 is not satisfied, i.e. when the time between the terminal departure time and the arrival time of the worker is not equal to or more than the reference time, the determination unit 14 determines that charging of the vehicle is impossible before departure from the terminal. Then, when the condition 2 is satisfied, i.e. when the time between the terminal departure time and the arrival time of the worker is equal to or more than the reference time, the determination unit 14 determines that charging of the vehicle is possible before departure from the terminal. The reference time may be a previously determined fixed value.

Alternatively, a reference time may be determined based on an electric power amount in which a vehicle should be charged. In this case, “a time required in order to charge in an electric power amount at a charging velocity” computed based on the charging velocity of a charging facility and the electric power amount in which a vehicle should be charged is computed as a reference time.

Alternatively, the determination unit 14 may confirm reservation information indicating reservation status of a charging facility installed at a terminal, and determines “Condition 3: There is availability of reservation for a charging facility between an arrival time of a worker and a terminal departure time”. When the condition 3 is not satisfied, i.e. when there is no availability of reservation, the determination unit 14 determines that charging of the vehicle is impossible before departure from the terminal. Then, when the condition 3 is satisfied, i.e. when there is availability of reservation, the determination unit 14 determines that charging of the vehicle is possible before departure from the terminal.

The arrival time of the worker is a time common to all workers (ex.: 8:30 a.m.), and may be previously registered in the transportation plan creation support apparatus 10. Alternatively, work schedule information indicating an arrival time of each worker on each day may be previously created, and registered in the transportation plan creation support apparatus 10. Then, the determination unit 14 may determine an arrival time of a worker, based on the pieces of information.

Alternatively, the determination unit 14 may determine whether a condition connecting, with an AND condition, any two or more of the above conditions 1 to 3 is satisfied. Then, the determination unit 14 may determine that charging of the vehicle is impossible before departure from the terminal when the condition is not satisfied, and may determine that charging of the vehicle is possible before departure from the terminal when the condition is satisfied.

Processing of Computing a Charge Amount of Charging Performed Before Departure from a Terminal

The determination unit 14 computes a first charge amount of charging a vehicle before departure from a terminal, based on at least one of a time between an arrival time of a worker and a terminal departure time, and reservation status of a charging facility.

### “Method 1”

For example, the determination unit 14 computes a charging time T₂, based on a time T₁ between an arrival time of a worker and a terminal departure time. For example, a value acquired by subtracting a predetermined preparation time (previously determined value) from T₁ may be computed as T₂. Then, the determination unit 14 computes, as a first charge amount, a smaller one of a product of T₂ and a charging velocity of a charging facility and an available capacity of a vehicle (100%—a capacity for (an SOC of the vehicle at a time of departure from the terminal)).

### “Method 2”

Alternatively, the determination unit 14 computes a charging time T₂, based on reservation status of a charging facility. For example, a length of an available slot for reservation (time period) is T₂. Then, the determination unit 14 computes, as a first charge amount, a smaller one of a product of T₂ and a charging velocity of the charging facility and an available capacity of a vehicle (100%—a capacity for (an SOC of the vehicle at a time of departure from the terminal)).

### “Method 3”

Alternatively, the determination unit 14 may compute, as T₂, a shorter one of a value acquired by subtracting a predetermined preparation time (previously determined value) from T₁ and a length of an available slot for reservation (time period). Then, the determination unit 14 computes, as the first charge amount, a smaller one of a product of T₂ and a charging velocity of a charging facility and an available capacity of a vehicle (100—a capacity for (an SOC of the vehicle at a time of departure from the terminal)).

### “Method 4”

Alternatively, the determination unit 14 may compute, as a first charge amount, an available capacity of a vehicle (100%—a capacity for (an SOC of the vehicle at a time of departure from the terminal)).

### Processing of Determining Whether a Point Where an SOC Drops Below a Reference Value Exists in a Change of an SOC of a Vehicle During Transportation When Charging is Performed by a First Charge Amount Before Departure From a Terminal

There are various ways of making the determination, and any method can be adopted.

For example, as described in the first example embodiment, when a point where an SOC drops below a reference value exists in a change of an SOC of the vehicle during transportation, an electric power amount required after an SOC drops below the reference value can be computed by utilizing electricity consumption determined for each section. When the first charge amount is equal to or more than an electric power amount required after an SOC drops below the reference value, the determination unit 14 may determine that a point where an SOC drops below the reference value does not exist in a change of an SOC of the vehicle during transportation when charging is performed by a first charge amount before departure from a terminal. Then, when the first charge amount is less than the electric power amount required after an SOC drops below the reference value, the determination unit 14 may determine that a point where an SOC drops below the reference value exists in a change of an SOC of the vehicle during transportation when charging is performed by a first charge amount before departure from a terminal.

As another method, an SOC change prediction unit 13 may re-predict a change of an SOC of a vehicle during transportation when transportation following a transportation plan is performed, with “a value acquired by adding the first charge amount to an SOC of the vehicle at a terminal departure time acquired by the terminal departure time SOC acquisition unit 12” as “an SOC of the vehicle at a time of departure from the terminal”. Then, the determination unit 14 may determine whether a point where an SOC drops below the reference value exists in the change of an SOC.

A determination result output unit 15 outputs a result of the determination of the determination unit 14.

A result of determination indicates at least one of “whether charging before departure from a terminal is possible”, “first charge amount, “whether a point where an SOC drops below a reference value exists in a change of an SOC of a vehicle during transportation when charging is performed by a first charge amount before departure from a terminal”, “when a point where an SOC drops below a reference value exists, the point of dropping”, and “when a point where an SOC drops below a reference value exists, an electric power amount that is insufficient in order to perform the transportation plan in such a way that an SOC does not drop below the reference value”.

Moreover, in a case in which a point where an SOC drops below a reference value does not exist in a change of an SOC of a vehicle during transportation when charging is performed by a first charge amount before departure from a terminal, the determination result output unit 15 may transmit, to a charging planning system that manages charging at a charging facility, a creation and registration instruction of a charging plan for charging the vehicle with the first charge amount before departure from the terminal. The charging planning system is a system network-connected to a charging facility, and is a system that performs reservation of charging, planning of start/end, and monitoring of a state.

The determination result output unit 15 transmits, to the charging planning system, for example, a creation and registration instruction of a charging plan for charging with the first charge amount by a T₁ time in a following morning. In response to this, the charging planning system confirms reservation status, and searches for a time period until the T₁ time in the following morning in which the first charge amount is chargeable. Then, the charging planning system registers the reservation for the time period that has been searched for. Note that, the registration instruction output by the determination result output unit 15 may include vehicle identification information of a vehicle targeted for charging processing. Then, the charging planning system can make a reservation for charging the vehicle in the time period that has been searched for.

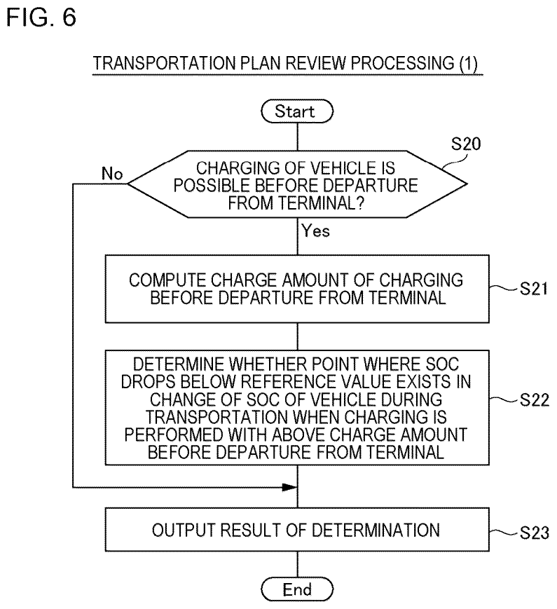

Next, one example of a flow of the above review processing executed by the transportation plan creation support apparatus 10 is described by use of a flowchart in FIG. 6.

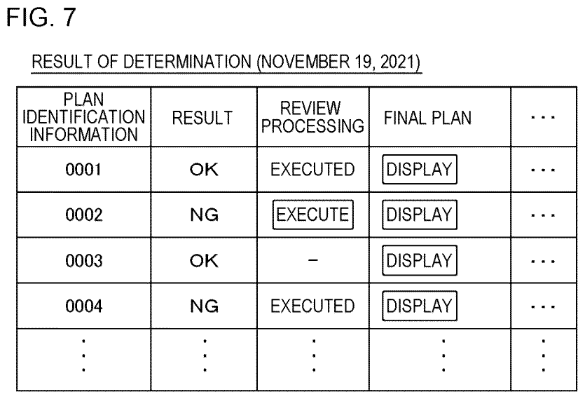

Note that, the review processing may be executed according to a user input. For example, as illustrated in FIG. 7, in a list display of determination results of a plurality of transportation plans, a button for starting review processing may be displayed in association with a transportation plan for which a determination result is NG. Then, in response to accepting an operation on the button, review processing for the transportation plan may be started.

Alternatively, in response to determination “a point where an SOC drops below a reference value exists in a change of an SOC of a vehicle during transportation” in S13 of FIG. 5, review processing for the transportation plan may be automatically started.

In S20, the transportation plan creation support apparatus 10 determines whether charging of the vehicle before departure from a terminal is possible.

When it is determined that charging is impossible (No in S20), the transportation plan creation support apparatus 10 outputs a result of the determination (S23).

On the other hand, when it is determined that charging is possible (Yes in S20), the transportation plan creation support apparatus 10 computes a first charge amount of charging before departure from the terminal (S21). Subsequently, the transportation plan creation support apparatus 10 determines whether a point where an SOC drops below a reference value exists in a change of an SOC of the vehicle during transportation when the vehicle is charged by the first charge amount before departure from the terminal (S22). Then, the transportation plan creation support apparatus 10 outputs a result of the determination (S23).

FIG. 7 illustrates a result output in S23. In a transportation plan for which review processing is “executed”, the above review processing has already been executed. A result (OK/NG) associated with the transportation plan indicates a determination result after the review processing. As a result of the review processing, there is a transportation plan for which a determination result is “OK” (e.g., plan identification information: 0001), and there is a transportation plan for which a determination result remains “NG” even though review processing is performed (e.g., plan identification information: 0004).

Note that, when accepting an operation on a display button for a final plan associated with each transportation plan, the determination result output unit 15 may display a final transportation plan. When review processing is performed, a transportation plan after the review processing becomes the final transportation plan. When review processing is not performed, a transportation plan acquired by a transportation plan acquisition unit 11 becomes the final transportation plan.

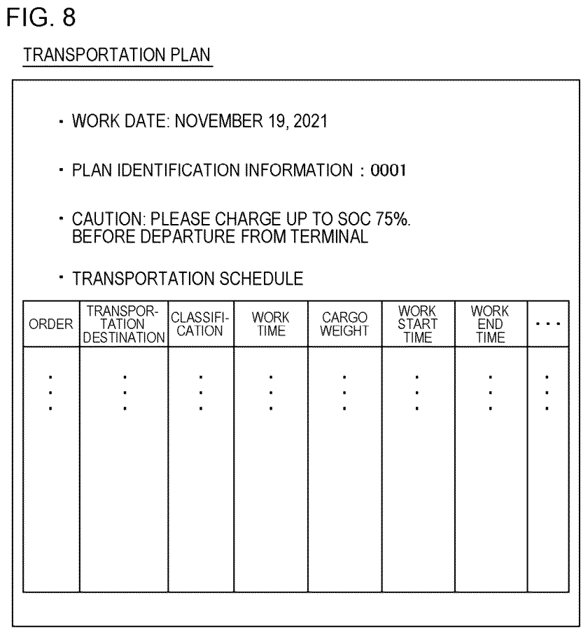

FIG. 8 schematically illustrates one example of a final transportation plan of a transportation plan (plan identification information: 0001) for which a determination result is “OK” as a result of review processing. In the illustrated example, a work date, plan identification information, a precaution, and a transportation schedule are displayed. The work date, the plan identification information, and the transportation schedule have the same contents as those in the transportation plan acquired by the transportation plan acquisition unit 11. The precaution indicates that charging is performed before departure from a terminal, and indicates a charge amount. In other words, the transportation plan is acquired by adding charging before departure from a terminal, to a transportation plan acquired by the transportation plan acquisition unit 11.

Moreover, although not illustrated in the figure, in a transportation plan for which a determination result is “NG” as a result of review processing, a precaution that a vehicle utilized for the transportation is changed to another vehicle (another electric vehicle, gasoline vehicle, diesel vehicle, or the like) may be given. In other words, the determination result output unit 15 may create and output a transportation plan in which a vehicle to be utilized is changed to another vehicle.

Other components of the transportation plan creation support apparatus 10 according to the present example embodiment are similar to those according to the first example embodiment.

The transportation plan creation support apparatus 10 according to the present example embodiment achieves an advantageous effect similar to that according to the first example embodiment. Moreover, the transportation plan creation support apparatus 10 according to the present example embodiment can determine whether charging can be performed before departure from a terminal, and whether an electricity failure of a vehicle occurs during transportation when charging is performed. The transportation plan creation support apparatus 10 according to the present example embodiment supports creation of a transportation plan by such a method.

### THIRD EXAMPLE EMBODIMENT

A transportation plan creation support apparatus 10 according to the present example embodiment is different from that according to the first example embodiment in having a function of reviewing (a function of correcting) a transportation plan in which a point where an SOC drops below a reference value exists in a change of an SOC of a vehicle during transportation. The function of reviewing a transportation plan according to the present example embodiment is different from that according to the second example embodiment. A detailed description is given below.

First, in a transportation plan, a break time is set. The break time is a time such as a time of eating lunch, a time of taking a rest at 10:00. a.m., 3:00 p.m., or the like. A length of a break time is a matter of design.

A determination unit 14 searches for a charging facility around a position of a vehicle in a break time, in a transportation plan in which an SOC drops below a reference value in a change of an SOC of the vehicle during transportation. Then, when there is a charging facility, the determination unit 14 computes a charge amount (hereinafter, a “second charge amount”) of charging performed in a break time. Then, the determination unit 14 determines whether a point where an SOC drops below a reference value exists in a change of an SOC of a vehicle during transportation when charging is performed by the second charge amount in a break time. Each piece of processing is described in detail below.

### Processing of Searching for a Charging Facility Around a Position of a Vehicle in a Break Time

First, the determination unit 14 determines a position of a vehicle in a break time (hereinafter, a “break position”). For determination of a break position, a determination is made based on a transportation plan. For example, a start time and an end time of a break are previously determined. A position where the vehicle exits at the start time of a break in a transportation route determined based on the transportation plan becomes a break position. Alternatively, a transportation destination immediately before a break may be determined as a break position. Alternatively, a transportation destination immediately after a break may be determined as a break position.

Subsequently, the determination unit 14 searches a charging facility list (information indicating a position of each of a plurality of charging facilities) previously stored in the transportation plan creation support apparatus 10, for a charging facility whose distance from the break position is equal to or less than a threshold value. The threshold value may be a previously determined fixed value. Alternatively, the determination unit 14 may compute the fixed value, based on a length of a break time. In this case, the longer a break time becomes, the larger the fixed value becomes.

Note that, a size of a vehicle may be considered in the search. For example, a charging facility list may indicate, in association with each charging facility, a size of a vehicle that can utilize each charging facility. When a site where a charging facility is installed is small, status in which a large vehicle cannot be utilized may arise. Then, the determination unit 14 may determine a size of a vehicle allocated to a transportation plan being a processing target, based on vehicle information previously stored in the transportation plan creation support apparatus 10, and then search for a charging facility whose distance from a break position is equal to or less than a threshold value, and in which a vehicle of the determined size can be utilized.

### Processing of Computing a Charge Amount of Charging Performed in a Break Time

The determination unit 14 computes a second charge amount of charging a vehicle in a break time, based on a distance between a position of a charging facility and a break position that has been searched for, and a length of a break time.

### “Method 1”

For example, the determination unit 14 computes, as a time T₃ of charging, a length of a break time indicated in a transportation plan. Then, the determination unit 14 computes, as a second charge amount, a smaller one of a product of T₃ and a charging velocity of a charging facility, and an available capacity of a vehicle (100%—a capacity for (an SOC of the vehicle during a break)).

### “Method 2”

For example, the determination unit 14 computes a time required to move from a break position to a position of a charging facility, based on a distance between a position of the charging facility and a break position that has been searched for. For example, a value acquired by dividing “a distance between a position of a charging facility and a break position” by a “reference velocity” may be computed as the time. A reference velocity is a previously determined value, and may be, for example, 50 km/h, 60 km/h, or the like.

Subsequently, the determination unit 14 computes, as a time T₃ charging, a time acquired by subtracting the time required for the movement from a length of the break time indicated in a transportation plan. Then, the determination unit 14 computes, as a second charge amount, a smaller one of a product of T₃ and a charging velocity of a charging facility, and an available capacity of a vehicle (100%—a capacity for (an SOC of the vehicle during a break)).

### “Method 3”

As another example, the determination unit 14 may compute, as the second charge amount, an available capacity of a vehicle (100%—a capacity for (an SOC of the vehicle during a break)).

### Processing of Determining Whether a Point Where an SOC Drops Below a Reference Value Exists in a Change of an SOC of a Vehicle During Transportation When Charging is Performed by a Second Charge Amount in a Break Time

There are various ways of making the determination, and any method can be adopted.

For example, as described in the first example embodiment, when a point where an SOC drops below a reference value exists in a change of an SOC of a vehicle during transportation, an electric power amount required after an SOC drops below the reference value can be computed by utilizing electricity consumption determined for each section. When the second charge amount is equal to or more than an electric power amount required after an SOC drops below the reference value, the determination unit 14 may determine that a point where an SOC drops below the reference value does not exist in a change of an SOC of the vehicle during transportation when charging is performed by a second charge amount in a break time. Then, when the second charge amount is less than the electric power amount required after an SOC drops below the reference value, the determination unit 14 may determine that a point where an SOC drops below the reference value exists in a change of an SOC of the vehicle during transportation when charging is performed by a second charge amount in a break time.

As another method, an SOC change prediction unit 13 may re-predict a change of an SOC of a vehicle during transportation when transportation following a transportation plan is performed, by adding a condition “charge by the second charge amount during a break”. Then, the determination unit 14 may determine whether a point where an SOC drops below the reference value exists in the change of an SOC.

A determination result output unit 15 outputs a result of the determination of the determination unit 14.

A result of determination indicates at least one of “whether charging in a break time is possible”, “second charge amount”, “details of a charging facility for charging in a break time (a place, or the like)”, “whether a point where an SOC drops below a reference value exists in a change of an SOC of a vehicle during transportation when charging is performed by a second charge amount in a break time”, “when a point where an SOC drops below a reference value exists, the point of dropping”, and “when a point where an SOC drops below a reference value exists, an electric power amount that is insufficient in order to perform the transportation plan in such a way that an SOC does not drop below the reference value”

Moreover, in a case in which a point where an SOC drops below a reference value does not exist in a change of an SOC of a vehicle during transportation when charging is performed by a second charge amount in a break time, the determination result output unit 15 may transmit, to a charging planning system that manages charging at a charging facility to be a target (a charging facility utilized for charging in a break time), a creation and registration instruction of a charging plan for charging the vehicle with the second charge amount in a break time. The charging planning system is a system network-connected to a charging facility, and is a system that performs reservation of charging, planning of start/end, and monitoring of a state.

The determination result output unit 15 transmits, to the charging planning system, for example, a creation and registration instruction of a charging plan for charging with the second charge amount between a T₂ time and a T₃ time of a following day. In response to this, the charging planning system confirms reservation status, and searches for a time period between the T₂ time and the T₃ time of the following day in which the second charge amount is chargeable. Then, the charging planning system registers the reservation for the time period that has been searched for. Note that, the registration instruction output by the determination result output unit 15 may include vehicle identification information of a vehicle targeted for charging processing. Then, the charging planning system can make a reservation for performing charging of the vehicle in the time period that has been searched for.

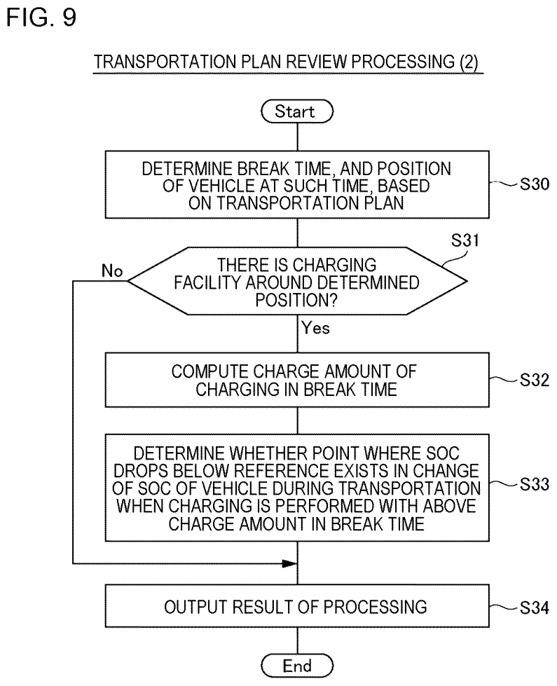

Next, one example of a flow of the above review processing executed by the transportation plan creation support apparatus 10 is described by use of a flowchart in FIG. 9.

Note that, the review processing may be executed according to a user input. For example, as illustrated in FIG. 7, in a list display of determination results of a plurality of transportation plans, a button for starting review processing may be displayed in association with a transportation plan for which a determination result is NG. Then, in response to accepting an operation on the button, review processing for the transportation plan may be started. Alternatively, in response to determination “a point where an SOC drops below a reference value exists in a change of an SOC of a vehicle during transportation” in S13 of FIG. 5, review processing for the transportation plan may be started.

In S30, the transportation plan creation support apparatus 10 determines a break time, and a position (break position) of the vehicle at the time, based on the transportation plan.

Subsequently, the transportation plan creation support apparatus 10 searches whether there is a charging facility around the determined break position (S31). When there is no charging facility around the break position (No in S31), the transportation plan creation support apparatus 10 outputs a determination result thereof (S34).

On the other hand, when there is a charging facility around the break position (Yes in S31), the transportation plan creation support apparatus 10 computes a charge amount (second charge amount) of charging in a break time

(S32). Subsequently, the transportation plan creation support apparatus 10 determines whether a point where an SOC drops below a reference value exists in a change of an SOC of a vehicle during transportation when charging is performed by a second charge amount in a break time (S33). Then, the transportation plan creation support apparatus 10 outputs a result of the determination (S34).

FIG. 7 illustrates a result output in S34. In a transportation plan for which review processing is “executed”, the above review processing has already been executed. A result (OK/NG) associated with the transportation plan indicates a determination result after the review processing. As a result of the review processing, there is a transportation plan for which a determination result is “OK” (e.g., plan identification information: 0001), and there is a transportation plan for which a determination result remains “NG” even though review processing is performed (e.g., plan identification information: 0004).

Note that, when accepting an operation on a display button for a final plan associated with each transportation plan, the determination result output unit 15 may display a final transportation plan. When review processing is performed, a transportation plan after the review processing becomes the final transportation plan. When review processing is not performed, a transportation plan acquired by a transportation plan acquisition unit 11 becomes the final transportation plan.

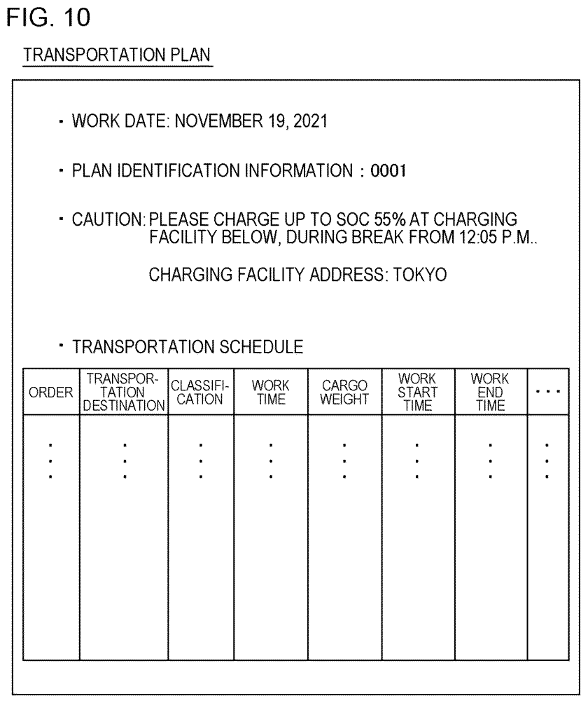

FIG. 10 schematically illustrates one example of a final transportation plan of a transportation plan (plan identification information: 0001) for which a determination result is “OK” as a result of review processing. In the illustrated example, a work date, plan identification information, a precaution, and a transportation schedule are displayed. The work date, the plan identification information, and the transportation schedule have the same contents as the transportation plan acquired by the transportation plan acquisition unit 11. The precaution indicates that charging is performed in a break time, indicates a charging place, and indicates a charge amount. In other words, the transportation plan is acquired by adding charging in a break time, to a transportation plan acquired by the transportation plan acquisition unit 11.

Moreover, although not illustrated in the figure, in a transportation plan for which a determination result is “NG” as a result of review processing, a precaution that a vehicle utilized for the transportation is changed to another vehicle (another electric vehicle, gasoline vehicle, diesel vehicle, or the like) may be given. In other words, the determination result output unit 15 may create and output a transportation plan in which a vehicle to be utilized is changed to another vehicle.

Other components of the transportation plan creation support apparatus 10 according to the present example embodiment are similar to those according to the first example embodiment.

The transportation plan creation support apparatus 10 according to the present example embodiment achieves an advantageous effect similar to that according to the first example embodiment. Moreover, the transportation plan creation support apparatus 10 according to the present example embodiment can determine whether charging can be performed in a break time, and whether an electricity failure of a vehicle occurs during transportation when charging is performed. The transportation plan creation support apparatus 10 according to the present example embodiment supports creation of a transportation plan by such a method.

### FOURTH EXAMPLE EMBODIMENT

A transportation plan creation support apparatus 10 according to the present example embodiment executes both pieces of review processing according to the second example embodiment and the third example embodiment. For example, when a point where an SOC drops below a reference value exists in a change of an SOC of a vehicle during transportation even though the review processing described in the second example embodiment is performed, the transportation plan creation support apparatus 10 may further perform the review processing described in the third example embodiment.

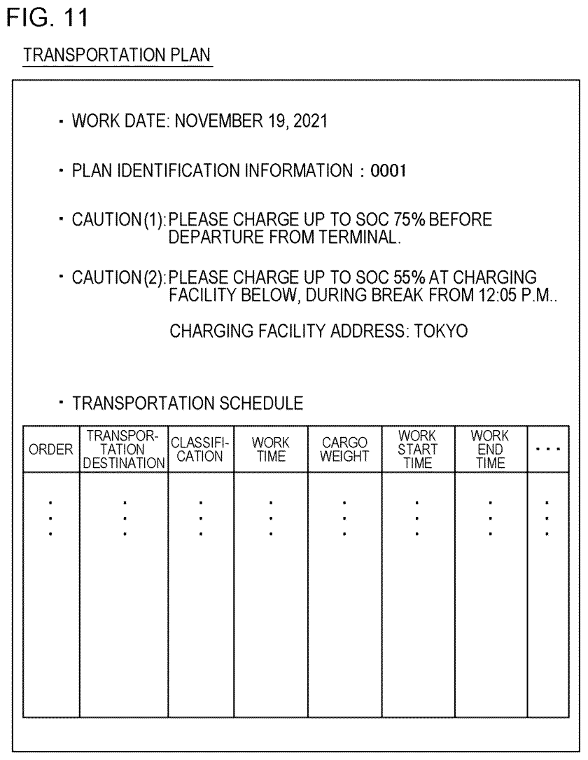

Alternatively, when a point where an SOC drops below a reference value exists in a change of an SOC of a vehicle during transportation even though the review processing described in the third example embodiment is performed, the transportation plan creation support apparatus 10 may further perform the review processing described in the second example embodiment. In these cases, as illustrated in FIG. 11, both charging before departure from a terminal and charging in a break time may be added to a final transportation plan.

Moreover, in the transportation plan for which a determination result is “NG” even though both charging before departure from a terminal and charging in a break time are considered, a precaution that a vehicle utilized for the transportation is changed to another vehicle (another electric vehicle, gasoline vehicle, diesel vehicle, or the like) may be given. In other words, the determination result output unit 15 may create and output a transportation plan in which a vehicle to be utilized is changed to another vehicle.

Other components of the transportation plan creation support apparatus 10 according to the present example embodiment are similar to those according to the first to third example embodiments.

The transportation plan creation support apparatus 10 according to the present example embodiment achieves an advantageous effect similar to that according to each of the first to third example embodiments.

### FIFTH EXAMPLE EMBODIMENT

The transportation plan creation support apparatus 10 according to the present example embodiment has a function of computing, based on charging reservation status of a vehicle, an SOC of the vehicle at a time of departure from a terminal. A detailed description is given below.

A terminal departure time SOC acquisition unit 12 acquires an SOC of a vehicle at a time of departure from a terminal by a method similar to those according to the first to fourth example embodiments. Moreover, the terminal departure time SOC acquisition unit 12 further acquires reservation information indicating reservation status of a charging facility. The reservation information indicates a reservation time (a reservation start time and a reservation end time), and vehicle identification information of a vehicle to be charged at the reservation time.

Then, the terminal departure time SOC acquisition unit 12 acquires an SOC (hereinafter, a “first SOC”) of the vehicle at the time of departure from the terminal by a method similar to those according to the first to fourth example embodiments, and then, regarding a vehicle for which reservation of a charging facility is made at and after the acquisition and before departure from the terminal, computes, as an SOC of the vehicle at the time of departure from the terminal, an SOC acquired by adding, to the first SOC, a charge amount for charging by the reservation. A charge amount for charging by a reservation can be smaller one of a product of a time from the reservation start time to the reservation end time and a charging velocity of a charging facility, and an available capacity of a vehicle (100%—a capacity for (first SOC)).

Other components of the transportation plan creation support apparatus 10 according to the present example embodiment are similar to those according to the first to fourth example embodiments.

The transportation plan creation support apparatus 10 according to the present example embodiment achieves an advantageous effect similar to that according to each of the first to fourth example embodiments. Moreover, the transportation plan creation support apparatus 10 according to the present example embodiment can determine an SOC of a vehicle at a time of departure from a terminal in consideration of charging processing before departure from the terminal that has already been scheduled before determination of a transportation plan, and determine whether a point where an SOC drops below a reference value exists in a change of an SOC of a vehicle during transportation. As a result, accuracy of determination is improved.

### SIXTH EXAMPLE EMBODIMENT

A transportation plan creation support apparatus 10 according to the present example embodiment has a function of predicting a change of an SOC of a vehicle during transportation, based on a type of a cargo. A detailed description is given below.

An SOC change prediction unit 13 determines, based on a transportation plan, whether an item of a first type is included in a cargo. In this case, a transportation plan indicates whether the cargo corresponds to the first type, in addition to a weight of the cargo and the like.

An item of the first type is an item such as frozen goods or refrigerated goods for which a special function (a refrigeration function, a freezing function, or the like) that a vehicle has needs to be utilized. Depending on whether the special function is utilized, a way of consumption of electric power of a vehicle also changes.

When a cargo includes an item of the first type, the SOC change prediction unit 13 predicts a change of an SOC of the vehicle during transportation on an assumption that work of transportation is performed in a state where electric power of the vehicle is on at a transportation destination. In this case, in a change of an SOC of the vehicle during transportation predicted by the SOC change prediction unit 13, electric power of the vehicle continues to be consumed even while work of transportation is performed at the transportation destination.

On the other hand, when a cargo does not include an item of the first type, the SOC change prediction unit 13 predicts a change of an SOC of the vehicle during transportation on an assumption that work of transportation is performed in a state where electric power of the vehicle is off at a transportation destination. In this case, in a change of an SOC of the vehicle during transportation predicted by the SOC change prediction unit 13, electric power of the vehicle is not consumed while work of transportation is performed at the transportation destination.

Note that, the SOC change prediction unit 13 may further consider whether a cargo includes an item of the first type, in determination of electricity consumption described in the first example embodiment. When a cargo includes an item of the first type, electricity consumption is high as compared to a case in which the cargo does not include an item of the first type.

Other components of the transportation plan creation support apparatus 10 according to the present example embodiment are similar to those according to the first to fifth example embodiments.

The transportation plan creation support apparatus 10 according to the present example embodiment achieves an advantageous effect similar to that according to each of the first to fifth example embodiments. Moreover, the transportation plan creation support apparatus 10 according to the present example embodiment can predict a change of an SOC of the vehicle during transportation, based on a type of a cargo. As a result, accuracy of the prediction is improved.

The example embodiments according to the present invention have been described above with reference to the drawings, but are exemplifications of the present invention, and various configurations other than those described above can be adopted. The components according to the example embodiments described above may be combined with each other, or some of the components may be replaced with other components. Moreover, various modifications may be made to the components according to the above-described example embodiments without departing from the spirit thereof. Moreover, the components and processing disclosed in each of the above example embodiments and modified examples may be combined with each other.

Note that, in the present specification, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Some or all of the above-described example embodiments can also be described as, but are not limited to, the following supplementary notes.
1. A transportation plan creation support apparatus including:
   a transportation plan acquisition unit that acquires a transportation plan including a transportation destination, an order of transportation, and a weight of a cargo:
   a terminal departure time SOC acquisition unit that acquires an SOC of a vehicle at a time of departure from a terminal:
   an SOC change prediction unit that determines, based on the transportation plan, a load during transportation changing in response to loading and unloading of the cargo during transportation, and predicts, based on the determined load, a change of an SOC of the vehicle during transportation when transportation following the transportation plan is performed:
   a determination unit that determines whether a point where an SOC drops below a reference value exists in a change of an SOC of the vehicle during transportation: and
   a determination result output unit that outputs a result of the determination.
2. The transportation plan creation support apparatus according to supplementary note 1, wherein
   the determination unit
      determines whether charging of the vehicle is possible before departure from a terminal, in the transportation plan in which an SOC drops below the reference value in a change of an SOC of the vehicle during transportation, and, when possible, determines whether a point where an SOC drops below a reference value exists in a change of an SOC of the vehicle during transportation when charging of the vehicle is performed before departure from a terminal.
3. The transportation plan creation support apparatus according to supplementary note 2, wherein
   the determination unit
      determines whether charging of the vehicle is possible before departure from a terminal, based on at least one of an SOC of the vehicle at a time of departure from a terminal, a time between an arrival time of a worker and a terminal departure time, and reservation status of a charging facility.
4 The transportation plan creation support apparatus according to supplementary note 2 or 3, wherein
   the determination unit
      computes a first charge amount of charging the vehicle before departure from a terminal, based on at least one of a time between an arrival time of a worker and a terminal departure time, and reservation status of a charging facility, when determining that charging of the vehicle is possible before departure from a terminal, and
      determines whether a point where an SOC drops below a reference value exists in a change of an SOC of the vehicle during transportation when the vehicle is charged by the first charge amount before departure from a terminal.
5. The transportation plan creation support apparatus according to any one of supplementary notes 2 to 4, wherein,
   when a point where an SOC drops below a reference value exists in a change of an SOC of the vehicle during transportation even though charging of the vehicle before departure from a terminal is considered, the determination result output unit creates and outputs the transportation plan in which a vehicle to be utilized is changed to another vehicle.
6. The transportation plan creation support apparatus according to supplementary note 4 or 5, wherein
   the determination result output unit transmits, to a charging planning system that manages charging at a charging facility, a creation and registration instruction of a charging plan for charging the vehicle with the first charge amount before departure from a terminal.
7. The transportation plan creation support apparatus according to any one of supplementary notes 1 to 6, wherein,
   in the transportation plan, a break time is set, and
   the determination unit
      searches for a charging facility around a position of the vehicle in the break time, in the transportation plan in which an SOC drops below the reference value in a change of an SOC of the vehicle during transportation, and, when there is a charging facility, determines whether a point where an SOC drops below a reference value exists in a change of an SOC of the vehicle during transportation when charging of the vehicle is performed in the break time.
8. The transportation plan creation support apparatus according to supplementary note 7, wherein
   the determination unit
      computes, when there is a charging facility around a position of the vehicle in the break time, a second charge amount of charging the vehicle in the break time, based on a distance between a position of the charging facility and a position of the vehicle in the break time, and a length of the break time, and
      determines whether a point where an SOC drops below a reference value exists in a change of an SOC of the vehicle during transportation when the vehicle is charged by the second charge amount in the break time.
9. The transportation plan creation support apparatus according to supplementary note 7 or 8, wherein,
   when a point where an SOC drops below a reference value exists in a change of an SOC of the vehicle during transportation even though charging of the vehicle in the break time is considered, the determination result output unit creates and outputs the transportation plan in which a vehicle to be utilized is changed to another vehicle.
10. The transportation plan creation support apparatus according to supplementary note 8 or 9, wherein
   the determination result output unit transmits, to a charging planning system that manages charging at a charging facility, a creation and registration instruction of a charging plan for charging the vehicle with the second charge amount in the break time.
11. The transportation plan creation support apparatus according to any one of supplementary notes 1 to 10, wherein
   the terminal departure time SOC acquisition unit
      computes, based on charging reservation status of the vehicle, an SOC of the vehicle at a time of departure from a terminal.
12. The transportation plan creation support apparatus according to any one of supplementary notes 1 to 11, wherein
   the SOC change prediction unit
      predicts, when the cargo includes an item of a first type, a change of an SOC of the vehicle during transportation on an assumption that work of loading and unloading of the cargo is performed in a state where electric power of the vehicle is on at a transportation destination, and
      predicts, when the cargo does not include an item of the first type, a change of an SOC of the vehicle during transportation on an assumption that work of loading and unloading of the cargo is performed in a state where electric power of the vehicle is off at a transportation destination.
13. A transportation plan creation support method including,
   by a computer executing:
      a transportation plan acquisition step of acquiring a transportation plan including a transportation destination, an order of transportation, and a weight of a cargo;
      a terminal departure time SOC acquisition step of acquiring an SOC of a vehicle at a time of departure from a terminal;
      an SOC change prediction step of determining, based on the transportation plan, a load during transportation changing in response to loading and unloading of the cargo, and predicting, based on the determined load, a change of an SOC of the vehicle during transportation when transportation following the transportation plan is performed;
      a determination step of determining whether a point where an SOC drops below a reference value exists in a change of an SOC of the vehicle during transportation; and
      a determination result output step of outputting a result of the determination.
14. A program causing a computer to function as:
   a transportation plan acquisition unit that acquires a transportation plan including a transportation destination, an order of transportation, and a weight of a cargo:
   a terminal departure time SOC acquisition unit that acquires an SOC of a vehicle at a time of departure from a terminal;
   an SOC change prediction unit that determines, based on the transportation plan, a load during transportation changing in response to transportation, and predicts, based on the determined load, a change of an SOC of the vehicle during transportation when transportation following the transportation plan is performed;
   a determination unit that determines whether a point where an SOC drops below a reference value exists in a change of an SOC of the vehicle during transportation; and
   a determination result output unit that outputs a result of the determination.

### REFERENCE SIGNS LIST

10 Transportation plan creation support apparatus
11 Transportation plan acquisition unit
12 Terminal departure time SOC acquisition unit
13 SOC change prediction unit
14 Determination unit
15 Determination result output unit
1A Processor
2A Memory
3A Input/output I/F
4A Peripheral circuit
5A Bus

What is claimed is:

1. A transportation plan creation support apparatus comprising:
at least one memory configured to store one or more instructions; and
at least one processor configured to execute the one or more instructions to:
acquire a transportation plan including a transportation destination, an order of transportation, and a weight of a cargo;
acquire an SOC (state of charge) of a vehicle at a time of departure from a terminal;
determine, based on the transportation plan, a load during transportation changing in response to loading and unloading of the cargo during transportation, and predict, based on the determined load, a change of an SOC of the vehicle during transportation when transportation following the transportation plan is performed;
determine whether a point where an SOC drops below a reference value exists in a change of an SOC of the vehicle during transportation; and
output a result of the determination.

2. The transportation plan creation support apparatus according to claim 1, wherein
the at least one processor is further configured to execute the one or more instructions to
determine whether charging of the vehicle is possible before departure from a terminal, in the transportation plan in which an SOC drops below the reference value in a change of an SOC of the vehicle during transportation, and, when possible, determine whether a point where an SOC drops below a reference value exists in a change of an SOC of the vehicle during transportation when charging of the vehicle is performed before departure from a terminal.

3. The transportation plan creation support apparatus according to claim 2, wherein
the at least one processor is further configured to execute the one or more instructions to
determine whether charging of the vehicle is possible before departure from a terminal, based on at least one of an SOC of the vehicle at a time of departure from a terminal, a time between an arrival time of a worker and a terminal departure time, and reservation status of a charging facility.

4. The transportation plan creation support apparatus according to claim 2, wherein
the at least one processor is further configured to execute the one or more instructions to
compute a first charge amount of charging the vehicle before departure from a terminal, based on at least one of a time between an arrival time of a worker and a terminal departure time, and reservation status of a charging facility, when determining that charging of the vehicle is possible before departure from a terminal, and
determine whether a point where an SOC drops below a reference value exists in a change of an SOC of the vehicle during transportation when the vehicle is charged by the first charge amount before departure from a terminal.

5. The transportation plan creation support apparatus according to claim 2, wherein the at least one processor is further configured to execute the one or more instructions to,
when a point where an SOC drops below a reference value exists in a change of an SOC of the vehicle during transportation even though charging of the vehicle before departure from a terminal is considered, create and output the transportation plan in which a vehicle to be utilized is changed to another vehicle.

6. The transportation plan creation support apparatus according to claim 4, wherein
the at least one processor is further configured to execute the one or more instructions to transmit, to a charging planning system that manages charging at a charging facility, a creation and registration instruction of a charging plan for charging the vehicle with the first charge amount before departure from a terminal.

7. The transportation plan creation support apparatus according to claim 1, wherein,
in the transportation plan, a break time is set, and
the at least one processor is further configured to execute the one or more instructions to
search for a charging facility around a position of the vehicle in the break time, in the transportation plan in which an SOC drops below the reference value in a change of an SOC of the vehicle during transportation, and, when there is a charging facility, determine whether a point where an SOC drops below a reference value exists in a change of an SOC of the vehicle during transportation when charging of the vehicle is performed in the break time.

8. The transportation plan creation support apparatus according to claim 7, wherein
the at least one processor is further configured to execute the one or more instructions to
compute, when there is a charging facility around a position of the vehicle in the break time, a second charge amount of charging the vehicle in the break time, based on a distance between a position of the charging facility and a position of the vehicle in the break time, and a length of the break time, and
determine whether a point where an SOC drops below a reference value exists in a change of an SOC of the vehicle during transportation when the vehicle is charged by the second charge amount in the break time.

9. The transportation plan creation support apparatus according to claim 7, wherein the at least one processor is further configured to execute the one or more instructions to,
when a point where an SOC drops below a reference value exists in a change of an SOC of the vehicle during transportation even though charging of the vehicle in the break time is considered, create and output the transportation plan in which a vehicle to be utilized is changed to another vehicle.

10. The transportation plan creation support apparatus according to claim 8, wherein
the at least one processor is further configured to execute the one or more instructions to transmit, to a charging planning system that manages charging at a charging facility, a creation and registration instruction of a charging plan for charging the vehicle with the second charge amount in the break time.

11. The transportation plan creation support apparatus according to claim 1, wherein
the at least one processor is further configured to execute the one or more instructions to
compute, based on charging reservation status of the vehicle, an SOC of the vehicle at a time of departure from a terminal.

12. The transportation plan creation support apparatus according to claim 1, wherein
the at least one processor is further configured to execute the one or more instructions to
predict, when the cargo includes an item of a first type, a change of an SOC of the vehicle during transportation on an assumption that work of loading and unloading of the cargo is performed in a state where electric power of the vehicle is on at a transportation destination, and
predict, when the cargo does not include an item of the first type, a change of an SOC of the vehicle during transportation on an assumption that work of loading and unloading of the cargo is performed in a state where electric power of the vehicle is off at a transportation destination.

13. A transportation plan creation support method comprising, by a computer executing:
acquiring a transportation plan including a transportation destination, an order of transportation, and a weight of a cargo;
acquiring an SOC of a vehicle at a time of departure from a terminal;
determining, based on the transportation plan, a load during transportation changing in response to loading and unloading of the cargo, and predicting, based on the determined load, a change of an SOC of the vehicle during transportation when transportation following the transportation plan is performed;
determining whether a point where an SOC drops below a reference value exists in a change of an SOC of the vehicle during transportation; and
outputting a result of the determination.

14. A non-transitory storage medium storing a program causing a computer to:
acquire a transportation plan including a transportation destination, an order of transportation, and a weight of a cargo;
acquire an SOC of a vehicle at a time of departure from a terminal;
determine, based on the transportation plan, a load during transportation changing in response to transportation, and predict, based on the determined load, a change of an SOC of the vehicle during transportation when transportation following the transportation plan is performed;
determine whether a point where an SOC drops below a reference value exists in a change of an SOC of the vehicle during transportation; and
output a result of the determination.

15. The transportation plan creation support method according to claim 13, wherein the computer
determines whether charging of the vehicle is possible before departure from a terminal, in the transportation plan in which an SOC drops below the reference value in a change of an SOC of the vehicle during transportation, and, when possible, determines whether a point where an SOC drops below a reference value exists in a change of an SOC of the vehicle during transportation when charging of the vehicle is performed before departure from a terminal.

16. The transportation plan creation support method according to claim 15, wherein the computer
determines whether charging of the vehicle is possible before departure from a terminal, based on at least one of an SOC of the vehicle at a time of departure from a terminal, a time between an arrival time of a worker and a terminal departure time, and reservation status of a charging facility.

17. The transportation plan creation support method according to claim 15, wherein the computer
computes a first charge amount of charging the vehicle before departure from a terminal, based on at least one of a time between an arrival time of a worker and a terminal departure time, and reservation status of a charging facility, when determining that charging of the vehicle is possible before departure from a terminal, and
determines whether a point where an SOC drops below a reference value exists in a change of an SOC of the vehicle during transportation when the vehicle is charged by the first charge amount before departure from a terminal.

18. The non-transitory storage medium according to claim 14, wherein the program causing the computer to
determine whether charging of the vehicle is possible before departure from a terminal, in the transportation plan in which an SOC drops below the reference value in a change of an SOC of the vehicle during transportation, and, when possible, determine whether a point where an SOC drops below a reference value exists in a change of an SOC of the vehicle during transportation when charging of the vehicle is performed before departure from a terminal.

19. The non-transitory storage medium according to claim 18, wherein the program causing the computer to
determine whether charging of the vehicle is possible before departure from a terminal, based on at least one of an SOC of the vehicle at a time of departure from a terminal, a time between an arrival time of a worker and a terminal departure time, and reservation status of a charging facility.

20. The non-transitory storage medium according to claim 18, wherein the program causing the computer to
compute a first charge amount of charging the vehicle before departure from a terminal, based on at least one of a time between an arrival time of a worker and a terminal departure time, and reservation status of a charging facility, when determining that charging of the vehicle is possible before departure from a terminal, and
determine whether a point where an SOC drops below a reference value exists in a change of an SOC of the vehicle during transportation when the vehicle is charged by the first charge amount before departure from a terminal.
